(19) United States
(12) Patent Application Publication
(10) Pub. No.: US 2026/0336379 A1
(43) Pub. Date: Oct. 29, 2026

(54) K0 SHAFT LOCKING MECHANISM FOR ASSEMBLY TO TRANSMISSION

(71) Applicant: Schaeffler Technologies AG & Co. KG, Herzogenaurach (DE)

(72) Inventor: Matthew Payne, Glenmont, OH (US)

(21) Appl. No.: 19/191,586

(22) Filed: Apr. 28, 2025

(51) Int. Cl. B60K 6/40; B60K 6/387; B60K 6/48

(52) U.S. Cl. CPC B60K 6/40; B60K 6/387; B60K 6/48; B60K 2006/4825; B60Y 2200/92

(57) ABSTRACT

The locking mechanism may include a spring-loaded pin with a geometric engagement with a plate in a shaft and a balance dam rotationally fixed to a torque converter cover by castellations. When axial force is applied to the pin through a hole in the shaft, the pin compresses a spring against the plate and engages the balance dam and the plate, locking together the shaft and the torque converter through the pin, the balance dam, and the castellations. When the axial force is removed, the spring disengages the pin from the balance dam allowing the shaft and the torque converter to rotate independently. The pin may engage with the torque converter during assembly with a transmission and retract once assembly tooling is removed.

### TECHNICAL FIELD

The present disclosure generally relates to hybrid powertrains, and more particularly, to assembling the hybrid powertrains.

### BACKGROUND

P2 hybrid modules selectively connect an engine to a transmission while providing the ability for an electric motor to also selectively provide power. The P2hybrid module are assembled with the transmission by pneumatically actuating a K0 clutch, thereby locking the rotation of the P2 hybrid module. The K0 clutch may be pressurized with air during assembly to allow the torque converter to be rotated with the K0 shaft for lining up pump drive flats and splines. However, some architectures of P2 hybrid modules have the K0 clutch be actuated from the transmission shaft such that the port to lock the K0 clutch is not accessible during assembly with the transmission. This means there is no external way to charge the K0 clutch with pressure to lock the torque converter and K0 shaft for assembly.

### SUMMARY

A hybrid module is described, in accordance with one or more embodiments of the present disclosure. The hybrid module may include: an electric-motor stator; an electric-motor rotor, the electric-motor stator and the electric-motor rotor configured as a radial flux motor; a K0 shaft defining a shaft counterbore axially through the K0 shaft, the shaft counterbore including a pilot hole and a body hole, a torque converter including a torque converter cover and a torque converter hub, the K0 shaft and the electric-motor stator configured to drive the torque converter; a balance dam defining a dam socket; a plate, the K0 shaft and the plate affixed together, the plate defining a plate socket; a hub, the electric-motor rotor, the balance dam, the hub, and the torque converter cover are non-rotatably connected; a K0 clutch disconnecting the K0 shaft and the hub when the K0 clutch is unlocked and non-rotatably connecting the K0 shaft and the hub when the K0 clutch is locked; and a locking mechanism disconnecting the K0 shaft and the balance dam when the locking mechanism is unlocked and non-rotatably connecting the K0 shaft and the balance dam when the locking mechanism is locked, the locking mechanism including a pin, the pin including a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism.

In some aspects, the circular portion and the drive portion are disposed on opposing axial ends of the pin.

In some aspects, the drive portion, the dam socket, and the plate socket include square cross-sections.

In some aspects, the body hole is defined axially from an end of the K0shaft which is adjacent to the balance dam through an axial depth of the K0 shaft up to the pilot hole, wherein the plate is disposed within the body hole.

In some aspects, the pin includes a shoulder portion, wherein the shoulder portion extends radially outwards from the circular portion, wherein the locking mechanism includes a pin-compression spring, wherein the shoulder portion and the pin-compression spring are disposed within the body hole of the shaft counterbore, wherein the pin-compression spring is axially disposed between and radially aligned with the shoulder portion and the plate, wherein the shoulder portion and the plate compress the pin-compression spring when the pin translates axially towards the plate and locks with the balance dam, wherein the pin-compression spring returns the pin axially away from the plate and unlocks the pin from the balance dam.

In some aspects, the circular portion and the pilot hole are connected by a cylindrical joint, wherein the drive portion and the plate socket are connected by a prismatic joint.

In some aspects, the locking mechanism includes a seal, wherein the seal is affixed to the circular portion.

In some aspects, the K0 shaft and the pin are non-rotatably connected by the drive portion and the plate socket when the locking mechanism is both locked and unlocked, wherein the pin and the balance dam are non-rotatably connected by the drive portion and the dam socket when the locking mechanism is locked and are disconnected when the locking mechanism is unlocked.

In some aspects, the plate is affixed to the K0 shaft by staking the K0 shaft to the plate.

In some aspects, the balance dam and the torque converter cover are affixed together via a plurality of castellations.

In some aspects, the hybrid module includes a front cover, wherein the electric-motor stator and the front cover are non-rotatably connected, wherein the hub and the K0 shaft are configured to rotate relative to and are supported by the front cover.

In some aspects, the K0 clutch includes first K0 clutch plates and second K0 clutch plates, wherein the K0 shaft and the first K0 clutch plates are non-rotatably connected, wherein the hub and the second K0 clutch plates are non-rotatably connected.

In some aspects, the electric-motor stator is configured to drive the torque converter via the electric-motor rotor, the hub, and the torque converter cover when the electric-motor stator is engaged, wherein the K0 shaft is configured to drive the torque converter via the K0 clutch, the hub, and the torque converter cover when the K0 clutch is locked.

In some aspects, the torque converter cover is configured to drive the torque converter hub through rotation of the torque converter cover, wherein the torque converter includes an impeller and a turbine, wherein the torque converter is configured to drive the torque converter hub through rotation of the torque converter cover using the impeller and the turbine.

In some aspects, the hybrid module includes a K0 piston, wherein the K0piston is configured to axially translate relative to the balance dam and the torque converter cover to lock and unlock the K0 clutch.

In some aspects, the hybrid module includes a hydraulic chamber, wherein the hydraulic chamber is axially disposed between and radially aligned with the K0piston and the torque converter cover, wherein the hydraulic chamber is configured to be filled with oil, wherein the K0 piston is configured to axially translate towards the balance dam to lock the K0 clutch and axially translate away from the balance dam to unlock the K0 clutch.

In some aspects, the torque converter cover defines an oil channel, wherein the hydraulic chamber is configured to receive the oil via the oil channel, wherein the oil channel is disposed radially inwards of and axially aligned with the hydraulic chamber, wherein the oil channel is only accessible from an axial opening defined by the torque converter hub.

In some aspects, the hybrid module includes a piston-compression spring, wherein the piston-compression spring is axially disposed between and radially aligned with the balance dam and the K0 piston, wherein the balance dam and the K0 piston are configured to compress the piston-compression spring when the K0piston translates axially towards the balance dam and locks the K0 clutch, wherein the piston-compression spring is configured to return the K0 piston axially away from the balance dam and unlock the K0 clutch.

A hybrid powertrain is described, in accordance with one or more embodiments of the present disclosure. The hybrid powertrain may include: a hybrid module including: an electric-motor stator; an electric-motor rotor, the electric-motor stator and the electric-motor rotor configured as a radial flux motor; a K0 shaft defining a shaft counterbore axially through the K0 shaft, the shaft counterbore including a pilot hole and a body hole, a torque converter including a torque converter cover and a torque converter hub, the K0 shaft and the electric-motor stator configured to drive the torque converter; a balance dam defining a dam socket; a plate, the K0 shaft and the plate affixed together, the plate defining a plate socket; a hub, the electric-motor rotor, the balance dam, the hub, and the torque converter cover are non-rotatably connected; a K0 clutch disconnecting the K0 shaft and the hub when the K0 clutch is unlocked and non-rotatably connecting the K0 shaft and the hub when the K0 clutch is locked; and a locking mechanism disconnecting the K0 shaft and the balance dam when the locking mechanism is unlocked and non-rotatably connecting the K0 shaft and the balance dam when the locking mechanism is locked, the locking mechanism including a pin, the pin including a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism; and a transmission including a transmission input shaft, the transmission input shaft affixed to the torque converter hub.

A system is described, in accordance with one or more embodiments of the present disclosure. The system may include: a hybrid module including: an electric-motor stator; an electric-motor rotor, the electric-motor stator and the electric-motor rotor configured as a radial flux motor; a K0 shaft defining a shaft counterbore axially through the K0 shaft, the shaft counterbore including a pilot hole and a body hole, a torque converter including a torque converter cover and a torque converter hub, the K0 shaft and the electric-motor stator configured to drive the torque converter; a balance dam defining a dam socket; a plate, the K0 shaft and the plate affixed together, the plate defining a plate socket; a hub, the electric-motor rotor, the balance dam, the hub, and the torque converter cover are non-rotatably connected; a K0 clutch disconnecting the K0 shaft and the hub when the K0 clutch is unlocked and non-rotatably connecting the K0 shaft and the hub when the K0 clutch is locked; and a locking mechanism disconnecting the K0 shaft and the balance dam when the locking mechanism is unlocked and non-rotatably connecting the K0 shaft and the balance dam when the locking mechanism is locked, the locking mechanism including a pin, the pin including a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism; an assembly fixture housing, and a pressure rod configured to be axially inserted through the assembly fixture housing and the K0 shaft up to the pin.

It is to be understood that both the foregoing general description and the following detailed description are exemplary and explanatory only and are not necessarily restrictive of the present disclosure. The accompanying drawings, which are incorporated in and constitute a part of the specification, illustrate subject matter of the disclosure. Together, the description and drawings serve to explain the principles of the disclosure.

### BRIEF DESCRIPTION OF THE DRAWINGS

The numerous advantages of the disclosure may be better understood by those skilled in the art by reference to the accompanying figures in which:

FIG. 1A illustrates a cross-section view of a hybrid module, in accordance with one or more embodiments of the present disclosure.

FIG. 1B illustrates a top-half cross-section view of the hybrid module with a locking mechanism which is unlocked, in accordance with one or more embodiments of the present disclosure.

FIG. 1C illustrates the top-half cross-section view of the hybrid module with the locking mechanism which is locked, in accordance with one or more embodiments of the present disclosure.

FIG. 1D illustrates a perspective view of the locking mechanism which is unlocked with a partial cutaway through a balance dam to more clearly illustrate a dam socket, in accordance with one or more embodiments of the present disclosure.

FIG. 1E illustrates a perspective view of the locking mechanism which is locked with the partial cutaway through the balance dam to more clearly illustrate the dam socket, in accordance with one or more embodiments of the present disclosure.

FIG. 1F illustrates a perspective view of a pin of the locking mechanism, in accordance with one or more embodiments of the present disclosure.

FIG. 1G illustrates a partial cross-section view of the hybrid module with the locking mechanism which is unlocked together with section views A-A and B-B, in accordance with one or more embodiments of the present disclosure.

FIG. 2A illustrates a simplified block diagram of a hybrid powertrain with the hybrid module, in accordance with one or more embodiments of the present disclosure.

FIG. 2B illustrates a cross-section view of the hybrid powertrain with the hybrid module and the locking mechanism which is unlocked, in accordance with one or more embodiments of the present disclosure.

FIG. 2C illustrates a cross-section view of the hybrid powertrain with the hybrid module and the locking mechanism which is locked, in accordance with one or more embodiments of the present disclosure.

FIG. 3A illustrates a cross-section view of a system for assembling the hybrid powertrain with the locking mechanism which is unlocked, in accordance with one or more embodiments of the present disclosure.

FIG. 3B illustrates a cross-section view of the system for assembling the hybrid powertrain with a pressure rod which is locking the locking mechanism, in accordance with one or more embodiments of the present disclosure.

FIG. 3C illustrates a cross-section view of the system for assembling the hybrid powertrain with the pressure rod which is locking the locking mechanism and with a transmission which is affixed to the hybrid module, in accordance with one or more embodiments of the present disclosure.

FIG. 3D illustrates a cross-section view of the system for assembling the hybrid powertrain with the locking mechanism which is unlocked and with the transmission which is affixed to the hybrid module, in accordance with one or more embodiments of the present disclosure.

### DETAILED DESCRIPTION

Embodiments of the present disclosure are described herein. It is to be understood, however, that the disclosed embodiments are merely examples and other embodiments can take various and alternative forms. The figures are not necessarily to scale; some features could be exaggerated or minimized to show details of components. Therefore, specific structural and functional details disclosed herein are not to be interpreted as limiting, but merely as a representative basis for teaching one skilled in the art to variously employ the embodiments. As those of ordinary skill in the art will understand, various features illustrated and described with reference to any one of the figures can be combined with features illustrated in one or more other figures to produce embodiments that are not explicitly illustrated or described. The combinations of features illustrated provide representative embodiments for typical applications. Various combinations and modifications of the features consistent with the teachings of this disclosure, however, could be desired for particular applications or implementations.

Embodiments of the present disclosure are directed to a K0 shaft locking mechanism for assembly to transmission. The locking mechanism may include a spring-loaded pin with a geometric engagement with a plate in a shaft and a balance dam rotationally fixed to a torque converter cover by castellations. When axial force is applied to the pin through a hole in the shaft, the pin compresses a spring against the plate and engages the balance dam and the plate, locking together the shaft and the torque converter through the pin, the balance dam, and the castellations. When the axial force is removed, the spring disengages the pin from the balance dam allowing the shaft and the torque converter to rotate independently. The pin may engage with the torque converter during assembly with a transmission and retract once assembly tooling is removed.

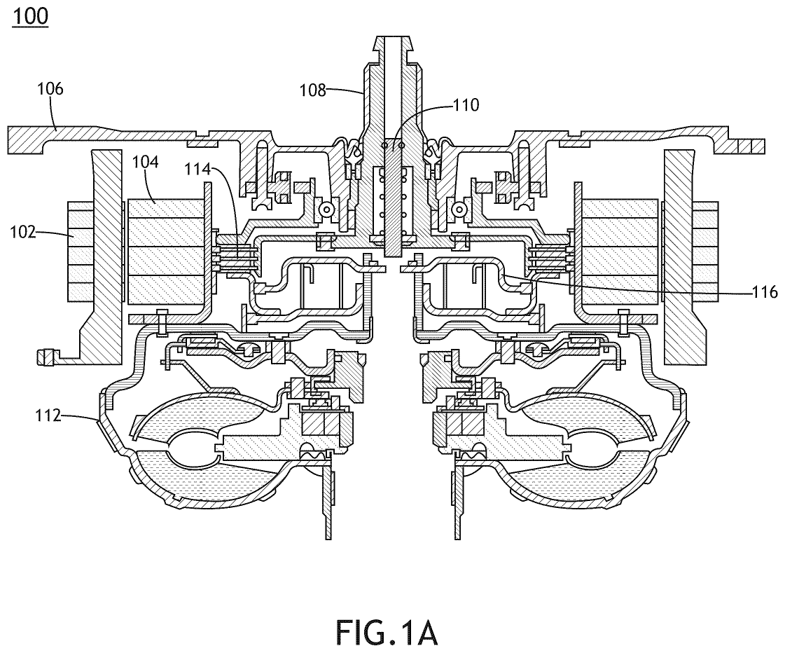

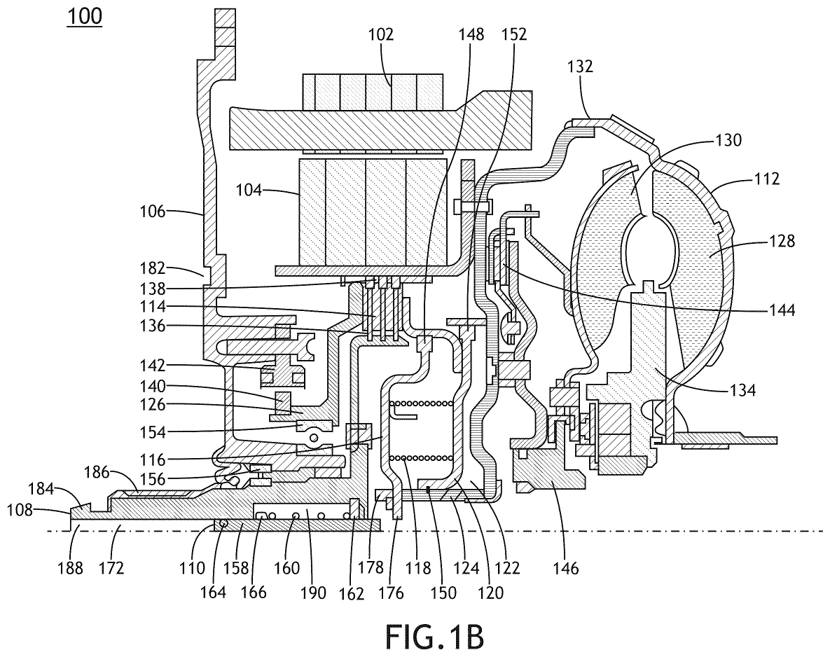

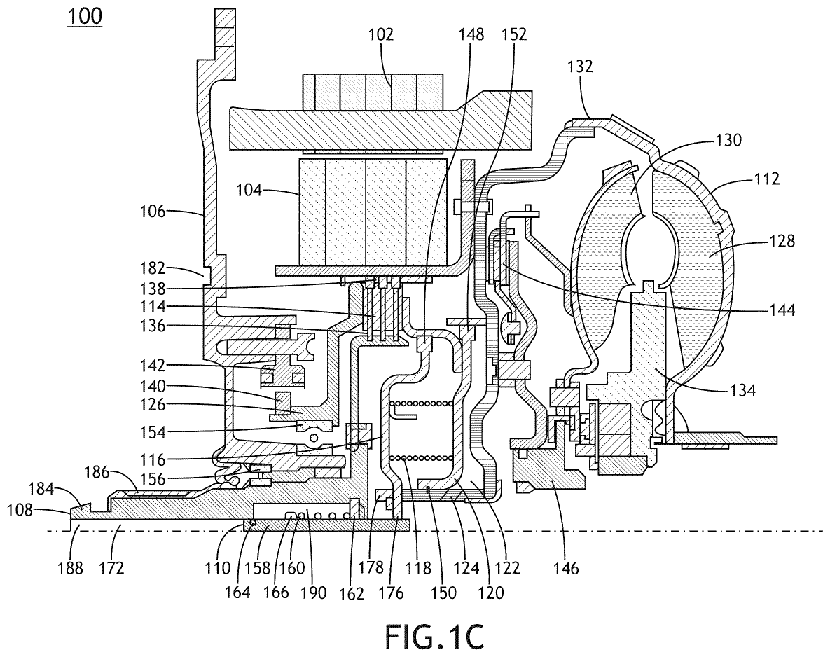

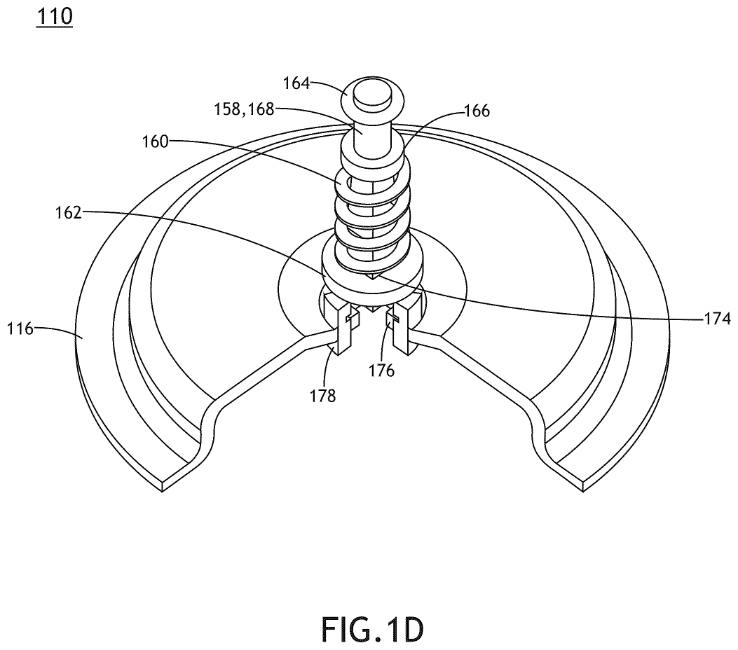

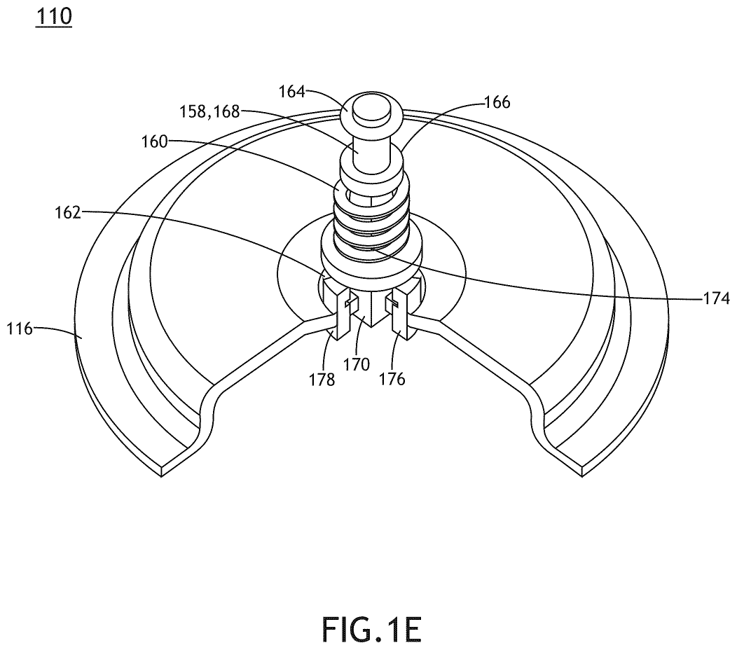

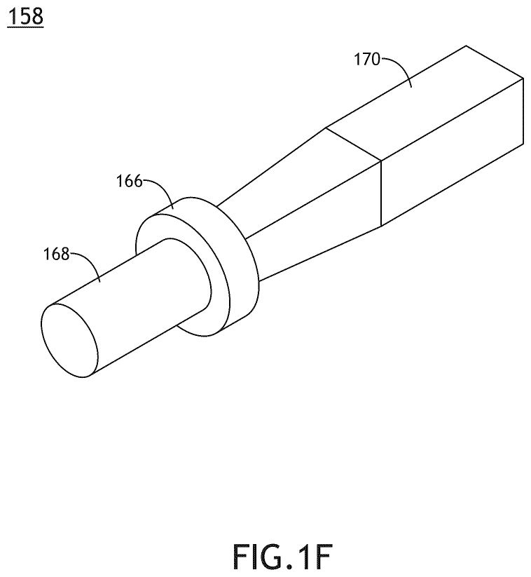

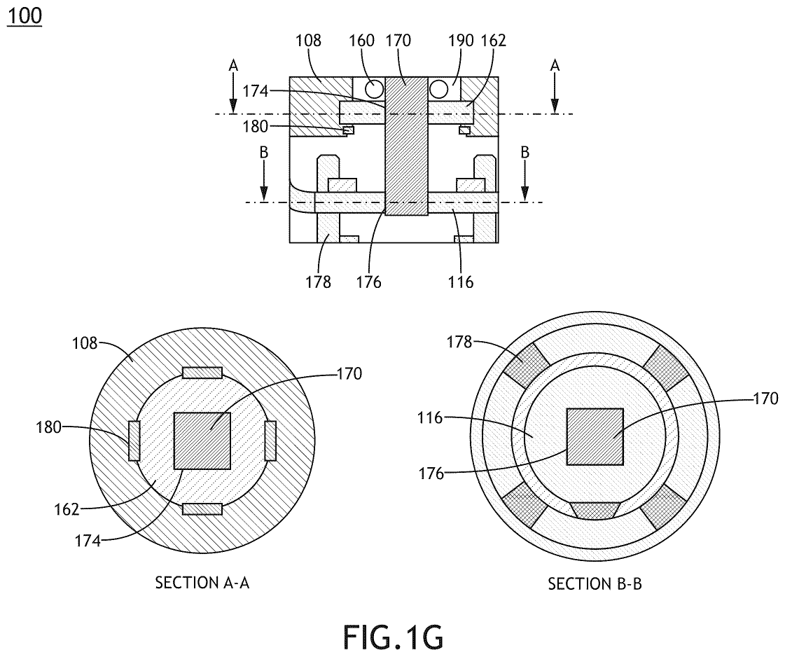

FIGS. 1A-1G illustrate a hybrid module 100, in accordance with one or more embodiments of the present disclosure. The hybrid module 100 may also be referred to as a P2 hybrid module, a P2 parallel hybrid module, or the like.

The hybrid module 100 may include one or more components, such as, but not limited to, an electric-motor stator 102, an electric-motor rotor 104, a front cover 106, a K0 shaft 108, a locking mechanism 110, a torque converter 112, a K0 clutch 114, a balance dam 116, piston-compression spring 118, a K0 piston 120, a hydraulic chamber 122, an oil channel 124, a hub 126, an impeller 128, a turbine 130, a torque converter cover 132, a torque converter stator 134, first K0 clutch plates 136, second K0 clutch plates 138, a resolver rotor 140, a resolver stator 142, a lock-up clutch 144, an torque converter hub 146, a seal 148, a seal 150, a seal 152, a bearing 154, a bearing 156, a pin 158, a pin-compression spring 160, a plate 162, a seal 164, a shoulder portion 166, a circular portion 168, a drive portion 170, a shaft counterbore 172, a plate socket 174, a dam socket 176, castellations 178, staking 180, blind-holes 182, a lifting knob 184, an external spline 186, a pilot hole 188, and/or a body hole 190.

The hybrid module 100 may be a parallel hybrid module. The K0 shaft 108 and the electric-motor stator 102 may drive the torque converter 112 in parallel or individually. The hybrid module 100 may function in at least three modes. In a first mode (e.g., an electric-motor-only mode), the K0 clutch 114 may be unlocked and the electric-motor stator 102 may be engaged, such that the electric-motor stator 102 may drive the torque converter 112. In a second mode (e.g., an internal-combustion-only mode), the K0 clutch 114 may be locked and the electric-motor stator 102 may be disengaged, such that the K0 shaft 108 may drive the torque converter 112. The electric-motor stator 102 may or may not regenerate charge from the rotation of the electric-motor rotor 104 in the second mode. In a third mode (e.g., an internal-combustion-and-electric-mode-parallel mode), the K0 clutch 114 may be locked and the electric-motor stator 102 may be engaged, such that the electric-motor stator 102 may both drive the torque converter 112. The third mode may also be used to start an internal combustion by the electric-motor stator 102 driving the rotation of the K0 shaft 108 via the electric-motor stator 102 and the K0 clutch 114.

One or more sets of components of the hybrid module 100 may be non-rotatably connected. A “non-rotatable connection” and derivatives thereof, such as “non-rotatably connected,” between first and second components may mean that the first component is connected to the second component so that any time the first component rotates, the second component rotates with the first component, and any time the second component rotates, the first component rotates with the second component. Axial displacement between the first and second components is possible.

The electric-motor stator 102, the front cover 106, and/or the resolver stator 142 may be non-rotatably connected. For example, an outer diameter of the resolver stator 142 may be affixed to the front cover 106. By way of another example, an outer diameter and/or an axial end of the front cover 106 may be affixed to the front cover 106 (not depicted).

The K0 shaft 108 and the first K0 clutch plates 136 of the K0 clutch 114 may be non-rotatably connected. For example, an outer diameter of the first K0 clutch plates 136 may be affixed to the K0 shaft 108.

The electric-motor rotor 104, the second K0 clutch plates 138 of the K0 clutch 114, the balance dam 116, the hub 126, the impeller 128, the torque converter cover 132, and/or the resolver rotor 140 may be non-rotatably connected. For example, an inner diameter of the electric-motor rotor 104 may be affixed to the hub 126. By way of another example, an outer diameter of the second K0 clutch plates 138 of the K0 clutch 114 may be affixed to the hub 126. By way of another example, the hub 126 may be affixed to the torque converter cover 132. By way of another example, the impeller 128 may be affixed to the torque converter cover 132. By way of another example, the balance dam 116 may be affixed to the torque converter cover 132. By way of another example, the resolver rotor 140 may be affixed to the hub 126.

The front cover 106 may be configured to support one or more components of the hybrid module 100. The hub 126 and/or the K0 shaft 108 may be configured to rotate relative to and be supported by the front cover 106. The bearing 154 may support the hub 126 on the front cover 106. The bearing 156 may support the K0 shaft 108 on the front cover 106.

The resolver rotor 140 and the resolver stator 142 may form a resolver assembly. The resolver assembly may be a variable-reluctance sensor, a hall-effect, an eddy current sensor, or the like. The resolver rotor 140 may be configured to rotate relative to the resolver stator 142. The resolver rotor 140 may be non-rotatably connected to an axial end of the hub 126. The resolver stator 142 may be non-rotatably connected to the front cover 106. The resolver stator 142 may be configured to sense the rotational position of the resolver rotor 140, and subsequently the rotational position of the hub 126 and the other components which are non-rotatably connected with the hub 126.

The electric-motor stator 102 and the electric-motor rotor 104 may be configured as a radial flux motor. For example, the radial flux motor may be an inner-rotor, outer-stator radial flux motor. The electric-motor rotor 104 may be disposed radially inwards of and axially aligned with the electric-motor stator 102. The electric-motor stator 102 may be configured to generate a magnetic field. The electric-motor rotor 104 may include permanent magnets which may magnetically couple with the magnetic field generated by the electric-motor stator 102. Thus, the electric-motor stator 102 may magnetically couple with the electric-motor rotor 104 and cause the electric-motor rotor 104 to rotate about the center axis of the hybrid module 100.

The K0 shaft 108 may also be referred to as a hybrid-module input shaft. The K0 shaft 108 may be configured to receive an input torque into the hybrid module 100.

The K0 clutch 114 may also be referred to as a disconnect clutch, an engine-disconnect clutch, a driveline-disconnect clutch, or the like. The K0 clutch 114 may be unlocked and locked. The K0 clutch 114 being locked may also be referred to as being closed. The K0 clutch 114 being unlocked may also be referred to as open. The K0 clutch 114 may disconnect the K0 shaft 108 and the hub 126 when the K0 clutch 114 is unlocked. The K0 clutch 114 may non-rotatably connect the K0 shaft 108 and the hub 126 when the K0 clutch 114 is locked. The K0 clutch 114 may be any suitable type of clutch, such as, but not limited to, a multiple-disc clutch, a clutch pack, or the like. The K0 clutch 114 may include the first K0 clutch plates 136 and the second K0 clutch plates 138. For example, the K0 clutch 114 may include the first K0 clutch plates 136 which are non-rotatably connected to an outer diameter of the K0 shaft 108 and the second K0 clutch plates 138 which are non-rotatably connected to an inner diameter of the hub 126. The second K0 clutch plates 138 may be configured to axially translate relative to the first K0 clutch plates 136 for locking to and unlocking from the first K0 clutch plates 136.

The torque converter 112 may be driven by the rotation of the hub 126. The non-rotatable connection between the hub 126 and the torque converter cover 132 may cause the torque converter cover 132 to rotate with the hub 126. The electric-motor stator 102 may drive the torque converter 112 via the electric-motor rotor 104, the hub 126, and/or the torque converter cover 132 when the electric-motor stator 102 is engaged. Similarly, the K0 shaft 108 may drive the torque converter 112 via the K0 clutch 114, the hub 126, and/or the torque converter cover 132 when the K0 clutch 114 is locked.

The torque converter 112 may include one or more components, such as, but not limited to, the impeller 128, the turbine 130, the torque converter cover 132, the torque converter stator 134, the lock-up clutch 144, and/or the torque converter hub 146. The torque converter 112 may drive the torque converter hub 146 through the rotation of the torque converter cover 132. The torque converter 112 may drive the torque converter hub 146 through the rotation of the torque converter cover 132 using any of the various components of the torque converter 112. The torque converter hub 146 may also be referred to as an output part, a pump hub, or the like.

The torque converter 112 may drive the torque converter hub 146 through the rotation of the torque converter cover 132 using the impeller 128 and the turbine 130. The rotatable connection between the torque converter cover 132 and the impeller 128 may cause the impeller 128 to rotate with the torque converter cover 132. Rotation of the turbine 130 may cause fluid to flow from turbine 130 to the impeller 128. The torque converter stator 134 may be disposed axially between the impeller 128 and the turbine 130 to redirect fluid flowing from the turbine 130 before the fluid reaches the impeller 128, to increase the efficiency of torque converter 112. The impeller 128 may receive the flow of fluid, thereby rotating the impeller 128 and the torque converter hub 146.

The torque converter 112 may also drive the torque converter hub 146 through the rotation of the torque converter cover 132 using the lock-up clutch 144. The lock-up clutch 144 may be configured to lock and unlock the torque converter cover 132 to and from the torque converter hub 146. The torque converter hub 146 may be non-rotatably connected to the torque converter cover 132 when the lock-up clutch 144 is locked. The lock-up clutch 144 may be beneficial to reduce inefficiencies associated with the impeller 128 and the turbine 130.

The K0 piston 120 may lock and unlock the K0 clutch 114. The K0 piston 120 may lock the K0 clutch 114 by forcing the second K0 clutch plates 138 against the first K0 clutch plates 136. The K0 piston 120 may unlock the K0 clutch 114 by releasing the second K0 clutch plates 138 from the first K0 clutch plates 136. The K0 piston 120 may be configured to axially translate to lock and unlock the K0 clutch 114. The K0 piston 120 may be configured to axially translate relative to one or more components of the hybrid module 100. The K0 piston 120 may be configured to axially translate relative to the balance dam 116 and/or to the torque converter cover 132. The K0 piston 120 may be axially translated towards the balance dam 116 to lock the K0 clutch 114 and axially translated away from the balance dam 116 to unlock the K0 clutch 114.

The K0 piston 120 may be sealed to one or more components of the hybrid module 100. The balance dam 116 and the K0 piston 120 may be sealed together. The balance dam 116 and the K0 piston 120 may be sealed together via the seal 148 at an outer diameter of the balance dam 116. The K0 piston 120 and the torque converter 112 (e.g., the torque converter cover 132) may also be sealed together. The K0 piston 120 and the torque converter 112 may be sealed together via the seal 150 at an inner diameter of the K0 piston 120 and/or via the seal 152 at an outer diameter of the K0 piston 120.

The hydraulic chamber 122 may be axially disposed between and radially aligned with the K0 piston 120 and the torque converter cover 132. The K0 piston 120, the torque converter cover 132, the seal 150, and/or the seal 152 may define the hydraulic chamber 122.

The K0 piston 120 may lock and unlock the K0 clutch 114 based on force differences on opposing sides of K0 piston 120. The piston-compression spring 118 and oil in the hydraulic chamber 122 may apply forces on the opposing sides of the K0 piston 120. When the force from the oil in the hydraulic chamber 122 is greater than the force from the piston-compression spring 118, the K0 piston 120 may lock the K0 clutch 114. Similarly, when the force from the oil in the hydraulic chamber 122 is less than the force from the piston-compression spring 118, the K0 piston 120 may unlock the K0 clutch 114. The hydraulic chamber 122 may be filled with high pressure oil. The pressure on the K0 piston 120 from the oil in the hydraulic chamber 122 may lock the K0 clutch 114. The hydraulic chamber 122 may be configured to receive the oil for providing a hydraulic pressure to the K0 piston 120 to lock the K0 clutch 114. The oil pressure may be relieved from the hydraulic chamber 122 to release the K0 piston 120 and unlock the K0 clutch 114.

The piston-compression spring 118 may also be referred to as a piston-return spring. The piston-compression spring 118 may be a compression spring which engages the K0 piston 120. The piston-compression spring 118 may be axially disposed between and radially aligned with the balance dam 116 and the K0 piston 120. The balance dam 116 and the K0 piston 120 may compress the piston-compression spring 118 when the K0 piston 120 translates axially towards the balance dam 116 and locks the K0 clutch 114. The piston-compression spring 118 may return the K0 piston 120 axially away from the balance dam 116 and unlock the K0 clutch 114. For example, the piston-compression spring 118 may return the K0 piston 120 and unlock the K0 clutch 114 when the fluid pressure in the hydraulic chamber 122 is relieved. The piston-compression spring 118 may return the K0 piston 120 up until a radially middle portion of the K0 piston 120 abuts the torque converter cover 132.

The hydraulic chamber 122 may be configured to receive the oil via the oil channel 124. The hydraulic chamber 122 may be fluidically coupled with the oil channel 124. The oil channel 124 may be a cross-drilled passage. The torque converter 112 may define the oil channel 124 to the hydraulic chamber 122. For example, the torque converter cover 132 may define the oil channel 124. The oil channel 124 may be disposed radially inwards of and axially aligned with the hydraulic chamber 122. The location of the oil channel 124 may provide difficulties with locking the K0 clutch 114 when assembling the hybrid module 100 in a hybrid powertrain (e.g., hybrid powertrain 200). For example, the oil channel 124 may be only accessible from an axial opening defined by the torque converter hub 146. The locking mechanism 110 may remedy the defects associated with the position of the oil channel 124.

The locking mechanism 110 may also be referred to as a mechanical clutch. The locking mechanism 110 may be locked and unlocked. The locking mechanism 110 may disconnect the K0 shaft 108 and the balance dam 116 when the locking mechanism 110 is unlocked. The locking mechanism 110 may non-rotatably connect the K0 shaft 108 and the balance dam 116 when the locking mechanism 110 is locked. The locking mechanism 110 may be packaged internally within the hybrid module 100. The locking mechanism 110 may include any suitable mechanical clutch, such as, but not limited to, a spring-loaded keyway. The locking mechanism 110 may include one or more components, such as, but not limited to, the pin 158, the pin-compression spring 160, the plate 162, the seal 164, the shoulder portion 166, the circular portion 168, the drive portion 170, the shaft counterbore 172, the plate socket 174, and/or the dam socket 176.

The K0 shaft 108 may define the shaft counterbore 172. The shaft counterbore 172 may be defined by inner diameters of the K0 shaft 108. The shaft counterbore 172 may include a pilot hole 188 and a body hole 190. The pilot hole 188 may have a smaller diameter than the body hole 190. The pilot hole 188 and the body hole 190 may be the smaller and larger inner diameters, respectively, of the shaft counterbore 172. The shaft counterbore 172 may be defined axially through the K0 shaft 108. For example, the pilot hole 188 of the shaft counterbore 172 may be defined axially through the K0 shaft 108. The body hole 190 of the shaft counterbore 172 may be defined axially from the end of the K0 shaft 108 which is adjacent to the balance dam 116 through an axial depth of the K0 shaft 108 up to the pilot hole 188.

The K0 shaft 108 and the plate 162 may be affixed together. The plate 162 may be affixed to the K0 shaft 108 using any suitable technique. For example, the plate 162 may be affixed to the K0 shaft 108 by staking 180 the K0 shaft 108 to the plate 162. Staking 180 may refer to plastically deforming the material of the K0 shaft 108 into the plate 162. The plate 162 may be disposed within the shaft counterbore 172. For example, the plate 162 may be disposed within the body hole 190 of the shaft counterbore 172. Disposing the plate 162 within the body hole 190 of the shaft counterbore 172 may be beneficial to make the locking mechanism 110 axially compact. It is further contemplated that the plate 162 may be affixed to the axial end of the K0 shaft 108.

The pin 158 may include the shoulder portion 166, the circular portion 168, and/or the drive portion 170. The circular portion 168 and the drive portion 170 may be disposed on opposing axial ends of the pin 158. The shoulder portion 166 may extend radially outwards from the circular portion 168. The pin 158 may or may not taper between the circular portion 168 and the drive portion 170. As depicted, the pin 158 tapers between the circular portion 168 and the drive portion 170, although this is not intended to be limiting.

The pin 158 may be disposed radially inwards of and axially aligned with the K0 shaft 108. For example, the circular portion 168 of the pin 158 may disposed radially inwards of and axially aligned with the shaft counterbore 172 of the K0 shaft 108. At least a portion of the circular portion 168 of the pin 158 may be disposed radially inwards of and axially aligned with the pilot hole 188 of the shaft counterbore 172. The pin 158 and the K0 shaft 108 may be connected by a cylindrical joint. For example, the circular portion 168 and the shaft counterbore 172 may be connected by the cylindrical joint. For instance, the circular portion 168 and the pilot hole 188 may be connected by the cylindrical joint. The cylindrical joint may be a two-degree-of-freedom joint. The pin 158 may be configured to axially translate relative to the K0 shaft 108 and rotate about the center axis relative to the K0 shaft 108 by the cylindrical joint. The cylindrical joint may prevent other forms of translation and rotation between the pin 158 and the K0 shaft 108.

The plate 162 be affixed to the K0 shaft 108 after the pin 158 is inserted within the shaft counterbore 172.

The K0 shaft 108 and the pin 158 may be sealed together. For example, the pilot hole 188 and the circular portion 168 may be sealed together. The K0 shaft 108 and the pin 158 may be sealed together via the seal 164. For example, the seal 164 may be formed between the circular portion 168 of the pin 158 and the pilot hole 188 of the shaft counterbore 172. The seal 164 may prevent oil disposed radially inwards of and axially aligned with the balance dam 116 from exiting the hybrid module 100 through the lifting knob 184 via the shaft counterbore 172.

The seal 164 may be affixed to the pin 158 or the K0 shaft 108. For example, the seal 164 may be affixed to the circular portion 168 of the pin 158 or the shaft counterbore 172 of the K0 shaft 108. As depicted, the seal 164 is affixed to the pin 158, although this is not intended to be limiting. For example, the seal 164 may be affixed to an axial end of the pin 158 defined by the circular portion 168. The seal 164 may axially translate with the pin 158 while sealing together the K0 shaft 108 and the pin 158. The shoulder portion 166 may be disposed axially between the seal 164 and the drive portion 170 of the pin 158.

The drive portion 170, the plate socket 174, and/or the dam socket 176 may provide a rotational locking geometry. The drive portion 170, the plate socket 174, and/or the dam socket 176 may include any suitable cross-section, such as, but not limited to, a triangular cross-section, a rectangular cross-section (e.g., a square cross-section), a hexagonal cross-section, or the like. As depicted, the drive portion 170, the plate socket 174, and/or the dam socket 176 include the square cross-section, although this is not intended to be limiting. The drive portion 170 may also be referred to as a male connection. The plate socket 174 and/or the dam socket 176 may also be referred to as a female connection. The drive portion 170 of the pin 158 may engage with the plate socket 174 and/or the dam socket 176.

The K0 shaft 108 and the pin 158 may be non-rotatably connected. For example, the K0 shaft 108 and the pin 158 may be non-rotatably connected by the drive portion 170 of the pin 158 and the plate socket 174 of the plate 162. The K0 shaft 108 and the pin 158 may be non-rotatably connected when the locking mechanism 110 is both locked and unlocked. The drive portion 170 may non-rotatably connect within the plate 162 by a socketing action. The plate 162 may define the plate socket 174. The socketing action may be formed between the drive portion 170 and the plate socket 174. The pin 158 may also be configured to axially translate relative to the K0 shaft 108 and the plate 162. The drive portion 170 of the pin 158 and the plate socket 174 of the plate 162 may be connected by a prismatic joint. The prismatic joint may be a one-degree-of-freedom joint. The prismatic joint may permit the pin 158 to axially translate relative to the K0 shaft 108 but may permit no other relative translation or relative rotation.

The pin 158 may be configured to axially translate relative to the K0 shaft 108, the plate 162, and/or the balance dam 116. The pin 158 may be axially translated towards the balance dam 116 to lock the locking mechanism 110 and axially translated away from the balance dam 116 to unlock the locking mechanism 110.

The pin 158 may lock and unlock the locking mechanism 110 based on opposing axial forces on the pin 158. The pin 158 may receive an axial force on the end of the circular portion 168. The pin-compression spring 160 may also apply an axial force on the pin 158. When the axial force on the end of the circular portion 168 is greater than the force from the pin-compression spring 160, the pin 158 may lock the locking mechanism 110 locking together the rotation of the K0 shaft 108 and the torque converter 112. Similarly, when the axial force on the end of the circular portion 168 is less than the force from the pin-compression spring 160, the pin 158 may unlock the locking mechanism 110 allowing the K0 shaft 108 and the torque converter 112 to rotate independently.

The pin 158 and the balance dam 116 may be non-rotatably connected when the locking mechanism 110 is locked and disconnected when the locking mechanism 110 is unlocked. The balance dam 116 may define the dam socket 176. The pin 158 and the balance dam 116 may be non-rotatably connected by the drive portion 170 of the pin 158 and the dam socket 176 of the balance dam 116. The drive portion 170 may non-rotatably connect within the balance dam 116 by a socketing action. The socketing action may be formed between the drive portion 170 and the dam socket 176. The drive portion 170 and the balance dam 116 may be connected by a prismatic joint when the locking mechanism 110 is locked. The prismatic joint may permit the pin 158 to axially translate relative to the balance dam 116 but may permit no other relative translation or relative rotation. Thus, the pin 158 may non-rotatably connect the K0 shaft 108 and the balance dam 116 when the locking mechanism 110 is locked. The pin 158 and the balance dam 116 may be disconnected when the locking mechanism 110 is unlocked. For example, the drive portion 170 may be disconnected from the dam socket 176 of the balance dam 116. In this regard, the drive portion 170 may be axially offset from the dam socket 176 of the balance dam 116 when the locking mechanism 110 is unlocked.

The balance dam 116 and the torque converter cover 132 may be affixed together. The balance dam 116 and the torque converter cover 132 may be affixed together via the castellations 178. The torque converter cover 132 may include the castellations 178. The castellations 178 may axially extend through and affix the balance dam 116. The K0 shaft 108 may then be non-rotatably connected with the torque converter 112 when the locking mechanism 110 is locked through the plate 162, the pin 158, the balance dam 116, and the torque converter cover 132. The castellations 178 may be axially affixed to the balance dam 116 via a snap-ring, or the like.

The pin-compression spring 160 may also be referred to as a pin-return spring. The pin-compression spring 160 may be a compression spring which engages the pin 158. The shoulder portion 166 and the pin-compression spring 160 may be disposed within the body hole 190 of the shaft counterbore 172. The pin-compression spring 160 may be axially disposed between and radially aligned with the shoulder portion 166 and the plate 162. The shoulder portion 166 and the plate 162 may compress the pin-compression spring 160 when the pin 158 translates axially towards the plate 162 and locks with the balance dam 116. The pin-compression spring 160 may return the pin 158 axially away from the plate 162 and unlock the pin 158 from the balance dam 116. For example, the pin-compression spring 160 may return the pin 158 when the axial force on the end of the circular portion 168 is removed. The pin-compression spring 160 may return the pin 158 up until the shoulder portion 166 abuts the portion of the K0 shaft 108 defining the pilot hole 188 of the shaft counterbore 172. The pin 158 may be a passive spring-loaded pin by the pin-compression spring 160. The locking mechanism 110 may be spring-loaded to unlock the locking mechanism 110 by the pin-compression spring 160. In this regard, the locking mechanism 110 may be a normally-unlocked mechanism. The pin-compression spring 160 may spring-load the pin 158 to axially translate the pin 158 and unlock the locking mechanism 110. The pin-compression spring 160 may spring-load the pin 158 by connecting between the shoulder portion 166 and the plate 162.

The front cover 106 may define the blind-holes 182. The blind-holes 182 may provide a reaction surface for rotating the front cover 106.

The K0 shaft 108 may include the lifting knob 184 and/or the external spline 186. The lifting knob 184 may be defined at an axial end of the K0 shaft 108 which is opposite to the balance dam 116. The lifting knob 184 may enable lifting the hybrid module 100. The lifting knob 184 may be axially offset from the external spline 186.

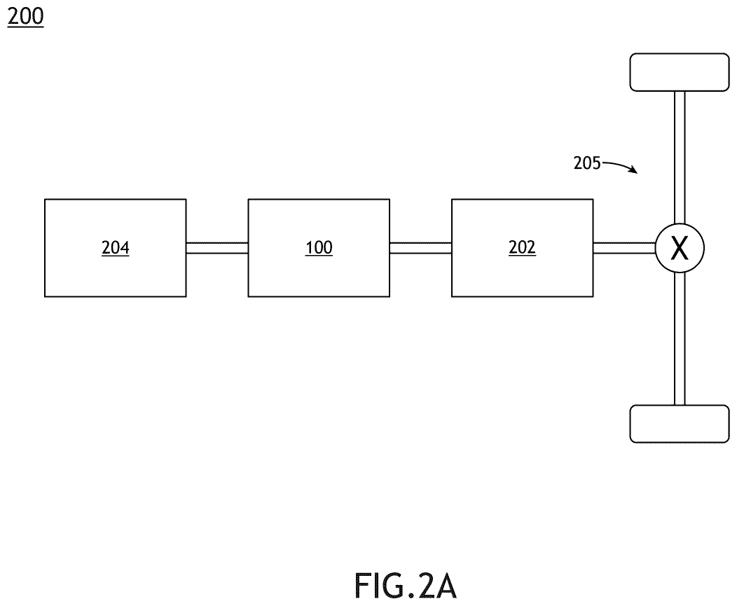

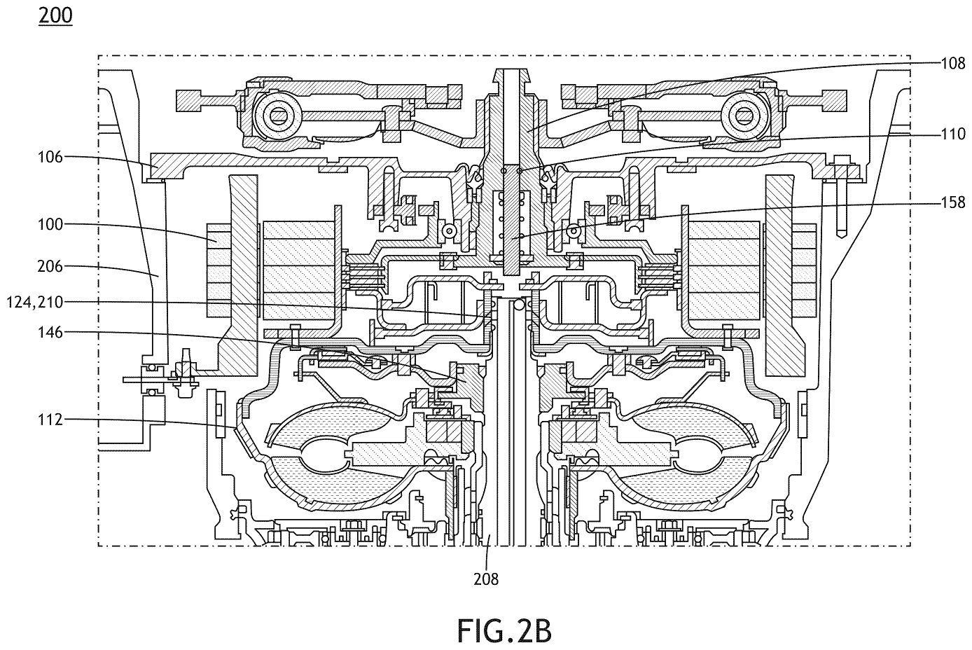

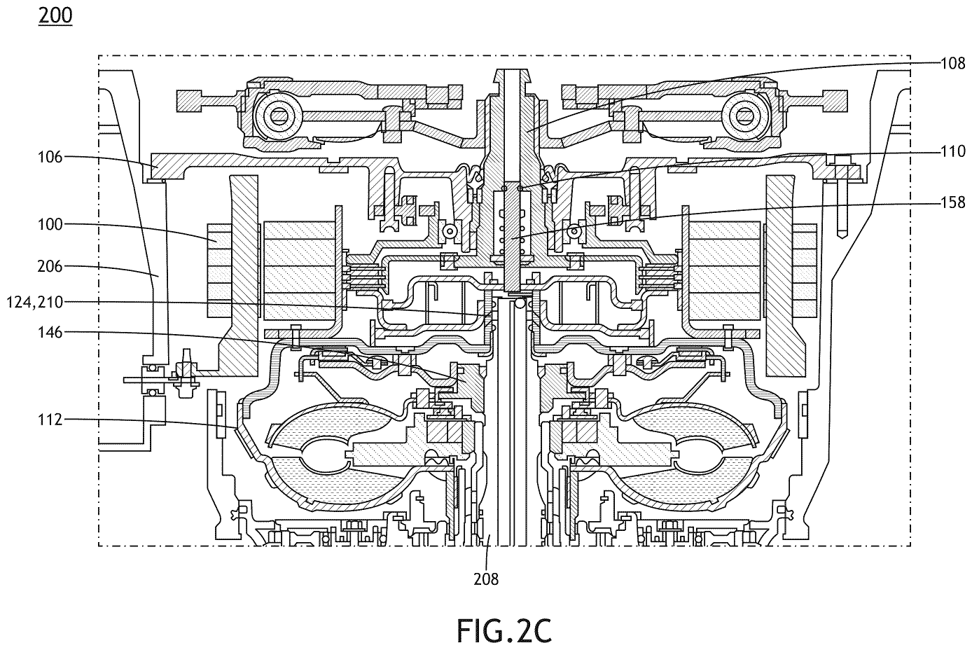

FIGS. 2A-2C illustrate a hybrid powertrain 200, in accordance with one or more embodiments of the present disclosure. The hybrid powertrain 200 may be a rear-wheel-drive hybrid powertrain. The hybrid powertrain 200 may include one or more components, such as, but not limited to, the hybrid module 100 and a transmission 202, an internal combustion engine 204, a driveline 205, a transmission bell housing 206, a transmission input shaft 208, and/or a transmission shaft port 210. The hybrid module 100 may be a P2 hybrid module and couple between the internal combustion engine 204 and the transmission 202. The hybrid module 100 may be selectively operable to transmit torque from the internal combustion engine 204 to the transmission 202, directly drive the transmission 202, and/or start the internal combustion engine 204.

The K0 shaft 108 may couple with the internal combustion engine 204. For example, the K0 shaft 108 may couple with a crankshaft of the internal combustion engine 204 via a flywheel. The K0 shaft 108 may receive torque from the internal combustion engine 204 when the internal combustion engine 204 is running. The K0 shaft 108 may also start the internal combustion engine 204.

The transmission 202 may include one or more components, such as, but not limited to, the transmission bell housing 206, the transmission input shaft 208, and/or the transmission shaft port 210.

The transmission bell housing 206 may house the hybrid module 100. For example, the hybrid module 100 may be disposed radially inwards of and axially aligned with the transmission bell housing 206. The front cover 106 and the transmission bell housing 206 may be affixed together.

The hybrid module 100 may be configured to rotate the transmission input shaft 208. The transmission input shaft 208 may be affixed to the torque converter hub 146 of the torque converter 112. The hybrid module 100 may rotate the transmission input shaft 208 by rotating the torque converter hub 146 using the torque converter 112. The transmission input shaft 208 may then drive the driveline 205 of the hybrid powertrain 200. The transmission 202 may be a multi-speed vehicle transmission. The transmission 202 may transmit torque to the driveline 205.

The locking mechanism 110 may be axially offset from the transmission input shaft 208. For example, the pin 158 may be axially offset from the transmission input shaft 208 when the locking mechanism 110 is unlocked and/or locked. In this regard, the pin 158 may not interfere with the transmission input shaft 208.

The oil channel 124 may be axially aligned with and fluidically coupled with a transmission shaft port 210 in the transmission input shaft 208. The oil may be pumped into the hydraulic chamber 122 using the transmission input shaft 208 through the transmission shaft port 210 and the oil channel 124. Thus, the flow of oil may be delivered to the hydraulic chamber 122 from the transmission 202. The transmission input shaft 208 may lock and unlock the K0 clutch 114 using the transmission shaft port 210. The oil channel 124 is not accessible when dropping the hybrid module 100 into the transmission bell housing 206 when affixing the torque converter hub 146 and the transmission input shaft 208. Thus, the K0 clutch 114 may be unable to non-rotatably connect the K0 shaft 108 and the torque converter 112.

The locking mechanism 110 may provide a means to non-rotatably connect the K0 shaft 108 and the torque converter 112 during assembly. The locking mechanism 110 may enable non-rotatably connecting the K0 shaft 108 and the torque converter 112 and ease the assembly when affixing the torque converter hub 146 and the transmission input shaft 208. Non-rotatably connecting the K0 shaft 108 and the torque converter 112 may be beneficial to ensure alignment when pressing together an internal spline of the torque converter hub 146 and an external spline of the transmission input shaft 208.

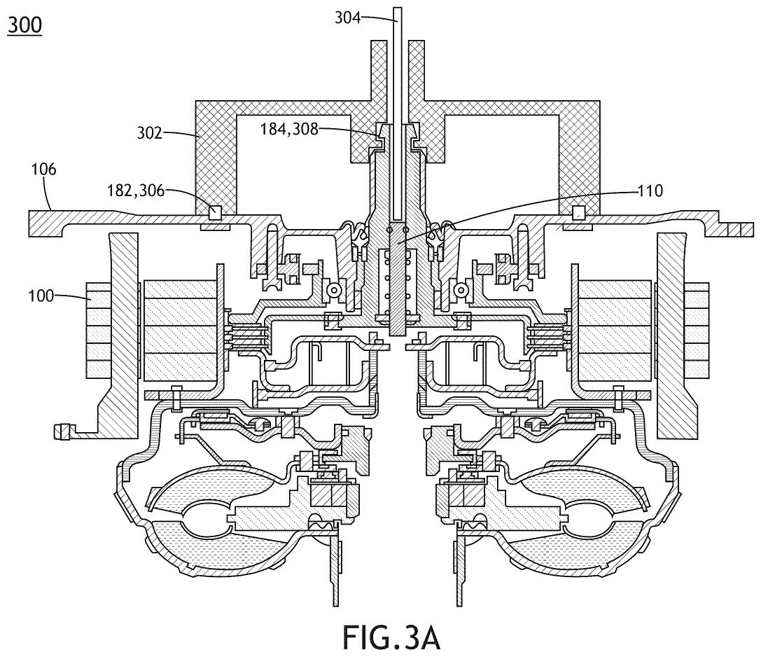

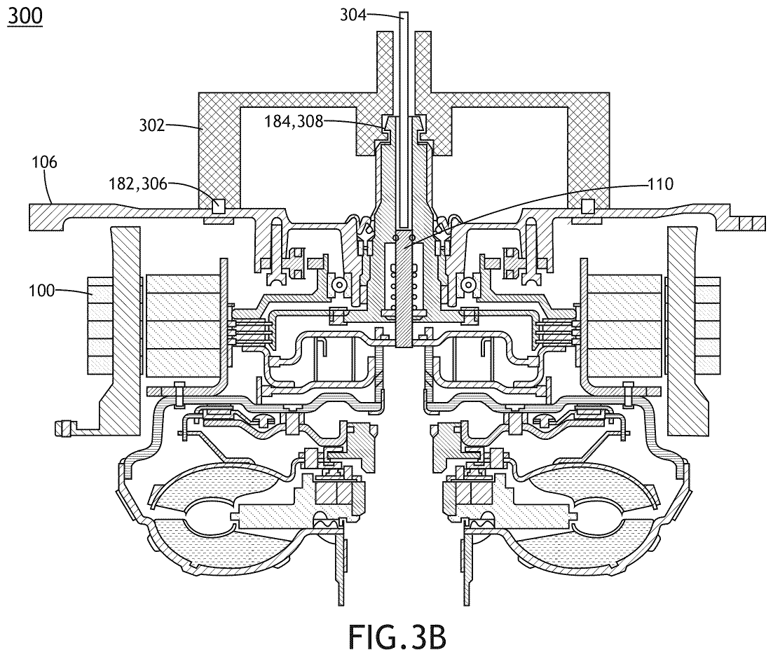

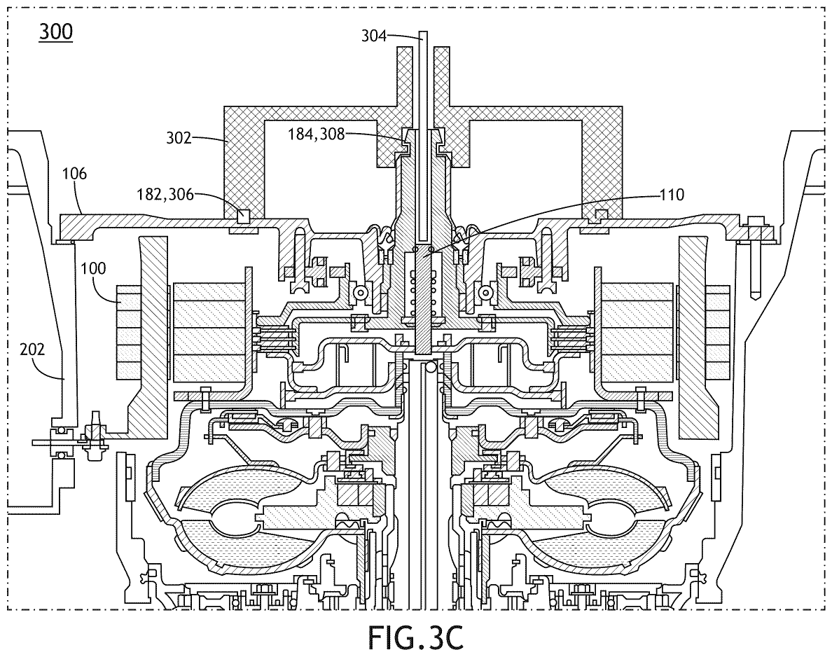

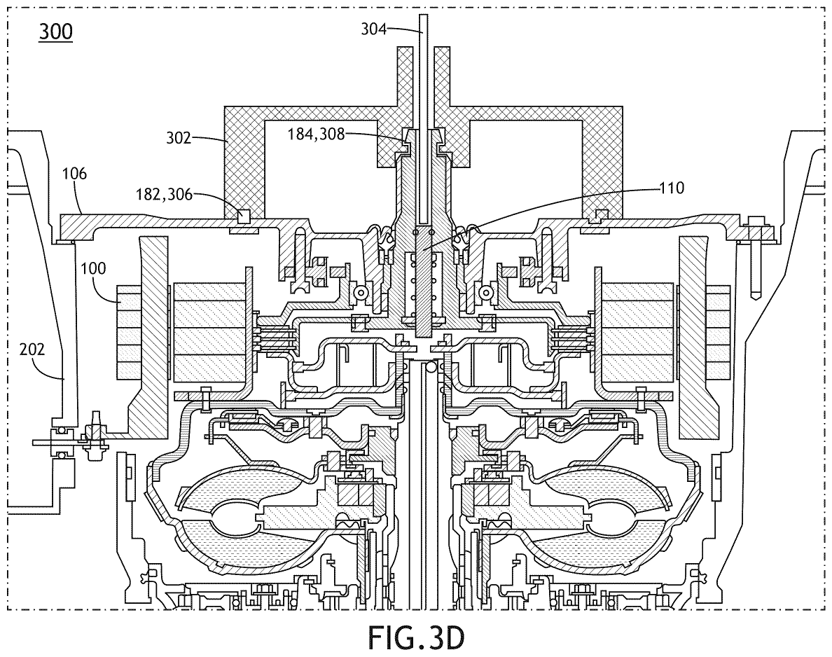

FIGS. 3A-3D illustrate a system 300, in accordance with one or more embodiments of the present disclosure. The system 300 may be used for assembling the hybrid powertrain 200. The system 300 may include the hybrid module 100, the transmission 202, an assembly fixture housing 302, and/or a pressure rod 304.

The assembly fixture housing 302 may include the dowels 306 and/or the reaction fork 308. The assembly fixture housing 302 and the front cover 106 may be non-rotatably connected. For example, the dowels 306 of the assembly fixture housing 302 may non-rotatably connect with the blind-holes 182 of the front cover 106. The dowels 306 and the blind-holes 182 may include a clearance fit. The assembly fixture housing 302 and the K0 shaft 108 may also be non-rotatably connected. For example, the reaction fork 308 may be affixed to the lifting knob 184 and/or the external spline 186 of the K0 shaft 108. The reaction fork 308 may be affixed to the lifting knob 184 using a removable shoulder of the reaction fork 308. The reaction fork 308 may be affixed to the external spline 186 by meshing with the external spline 186.

The pressure rod 304 may be axially inserted through the assembly fixture housing 302 and/or the K0 shaft 108 up to the pin 158. For example, the pressure rod 304 may be axially inserted through the pilot hole 188 of the shaft counterbore 172. The pressure rod 304 may apply the axial force on the pin 158, causing the locking mechanism 110 to lock. The axial force may be applied to the end of the circular portion 168 of the pin 158 thereby locking the locking mechanism 110 during assembly. The locking mechanism 110 may lock the K0 shaft 108 to the torque converter 112, such that the K0 shaft 108 may be used to align the torque converter 112 with the transmission input shaft 208 when lowering the hybrid module 100 down into the transmission bell housing 206. The pin 158 may remain engaged with the dam socket 176 during assembly. The pressure rod 304 may then release the axial pressure on the pin 158 after the torque converter hub 146 is affixed to the transmission input shaft 208. The pin 158 is then released, allowing the K0 shaft 108 to rotate independently of the torque converter 112 until the K0 clutch 114 is locked. The assembly fixture housing 302 may then be uncoupled from the hybrid module 100. After the hybrid module 100 is coupled to the transmission 202, the locking mechanism 110 may not be used. In this regard, the locking mechanism 110 may only be used during the assembly with the transmission 202.

Referring generally again to the figures. The seal 148, the seal 150, the seal 152, the seal 164 may include any suitable type of seal, such as, but not limited to, lip seals, O-ring gaskets, or the like. The piston-compression spring 118 and/or the pin-compression spring 160 may include any suitable type of compression spring, such as, but not limited to, a coil spring.

One skilled in the art will recognize that the herein described components operations, devices, objects, and the discussion accompanying them are used as examples for the sake of conceptual clarity and that various configuration modifications are contemplated. Consequently, as used herein, the specific exemplars set forth and the accompanying discussion are intended to be representative of their more general classes. In general, use of any specific exemplar is intended to be representative of its class, and the non-inclusion of specific components, operations, devices, and objects should not be taken as limiting.

As used herein, the term “axial” and derivatives thereof, such as “axially,” shall be understood to refer to a direction along the axis. The term “coaxial” shall be understood to refer to a common axis. Further, the term “radial” and derivatives thereof, such as “radially,” shall be understood in relation to the axis. For example, “radially outward” refers to further away from the axis, while “radially inward” refers to nearer to the axis. The term “circumference” or derivatives thereof, such as “circumferentially”, may also be defined in reference to the center axis.

As used herein, directional terms such as “top,” “bottom,” “over,” “under,” “upper,” “upward,” “lower,” “down,” and “downward” are intended to provide relative positions for purposes of description, and are not intended to designate an absolute frame of reference. Various modifications to the described embodiments will be apparent to those with skill in the art, and the general principles defined herein may be applied to other embodiments

With respect to the use of substantially any plural and/or singular terms herein, those having skill in the art can translate from the plural to the singular and/or from the singular to the plural as is appropriate to the context and/or application. The various singular/plural permutations are not expressly set forth herein for sake of clarity.

While exemplary embodiments are described above, it is not intended that these embodiments describe all possible forms encompassed by the claims. The words used in the specification are words of description rather than limitation, and it is understood that various changes can be made without departing from the spirit and scope of the disclosure. As previously described, the features of various embodiments can be combined to form further embodiments of the disclosure that may not be explicitly described or illustrated. While various embodiments could have been described as providing advantages or being preferred over other embodiments or prior art implementations with respect to one or more desired characteristics, those of ordinary skill in the art recognize that one or more features or characteristics can be compromised to achieve desired overall system attributes, which depend on the specific application and implementation. As such, to the extent any embodiments are described as less desirable than other embodiments or prior art implementations with respect to one or more characteristics, these embodiments are not outside the scope of the disclosure and can be desirable for particular applications.

### LIST OF REFERENCE NUMBERS

100 hybrid module
102 electric-motor stator
104 electric-motor rotor
106 front cover
108 K0 shaft
110 locking mechanism
112 torque converter
114 K0 clutch
116 balance dam
118 piston-compression spring
120 K0 piston
122 hydraulic chamber
124 oil channel
126 hub
128 impeller
130 turbine
132 torque converter cover
134 torque converter stator
136 first K0 clutch plates
138 second K0 clutch plates
140 resolver rotor
142 resolver stator
144 lock-up clutch
146 torque converter hub
148 seal
150 seal
152 seal
154 bearing
156 bearing
158 pin
160 pin-compression spring
162 plate
164 seal
166 shoulder portion
168 circular portion
170 drive portion
172 shaft counterbore
174 plate socket
176 dam socket
178 castellations
180 staking
182 blind-holes
184 lifting knob
186 external spline
188 pilot hole
190 body hole
200 hybrid powertrain
202 transmission
204 internal combustion engine
205 driveline
206 transmission bell housing
208 transmission input shaft
210 transmission shaft port
300 system
302 assembly fixture housing
304 pressure rod
306 dowels
308 reaction fork

What is claimed:

1. A hybrid module comprising:
an electric-motor stator;
an electric-motor rotor, the electric-motor stator and the electric-motor rotor configured as a radial flux motor;
a K0 shaft defining a shaft counterbore axially through the K0 shaft, the shaft counterbore comprising a pilot hole and a body hole,
a torque converter comprising a torque converter cover and a torque converter hub, the K0 shaft and the electric-motor stator configured to drive the torque converter;
a balance dam defining a dam socket;
a plate, the K0 shaft and the plate affixed together, the plate defining a plate socket;
a hub, the electric-motor rotor, the balance dam, the hub, and the torque converter cover are non-rotatably connected;
a K0 clutch disconnecting the K0 shaft and the hub when the K0 clutch is unlocked and non-rotatably connecting the K0 shaft and the hub when the K0 clutch is locked; and
a locking mechanism disconnecting the K0 shaft and the balance dam when the locking mechanism is unlocked and non-rotatably connecting the K0 shaft and the balance dam when the locking mechanism is locked, the locking mechanism comprising a pin, the pin comprising a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism.

2. The hybrid module of claim 1, wherein the circular portion and the drive portion are disposed on opposing axial ends of the pin.

3. The hybrid module of claim 1, wherein the drive portion, the dam socket, and the plate socket comprise square cross-sections.

4. The hybrid module of claim 1, wherein the body hole is defined axially from an end of the K0 shaft which is adjacent to the balance dam through an axial depth of the K0 shaft up to the pilot hole, wherein the plate is disposed within the body hole.

5. The hybrid module of claim 1, wherein the pin comprises a shoulder portion, wherein the shoulder portion extends radially outwards from the circular portion, wherein the locking mechanism comprises a pin-compression spring, wherein the shoulder portion and the pin-compression spring are disposed within the body hole of the shaft counterbore, wherein the pin-compression spring is axially disposed between and radially aligned with the shoulder portion and the plate, wherein the shoulder portion and the plate compress the pin-compression spring when the pin translates axially towards the plate and locks with the balance dam, wherein the pin-compression spring returns the pin axially away from the plate and unlocks the pin from the balance dam.

6. The hybrid module of claim 1, wherein the circular portion and the pilot hole are connected by a cylindrical joint, wherein the drive portion and the plate socket are connected by a prismatic joint.

7. The hybrid module of claim 1, wherein the locking mechanism comprises a seal, wherein the seal is affixed to the circular portion.

8. The hybrid module of claim 1, wherein the K0 shaft and the pin are non-rotatably connected by the drive portion and the plate socket when the locking mechanism is both locked and unlocked, wherein the pin and the balance dam are non-rotatably connected by the drive portion and the dam socket when the locking mechanism is locked and are disconnected when the locking mechanism is unlocked.

9. The hybrid module of claim 1, wherein the plate is affixed to the K0 shaft by staking the K0 shaft to the plate.

10. The hybrid module of claim 1, wherein the balance dam and the torque converter cover are affixed together via a plurality of castellations.

11. The hybrid module of claim 1, wherein the hybrid module comprises a front cover, wherein the electric-motor stator and the front cover are non-rotatably connected, wherein the hub and the K0 shaft are configured to rotate relative to and are supported by the front cover.

12. The hybrid module of claim 1, wherein the K0 clutch comprises first K0 clutch plates and second K0 clutch plates, wherein the K0 shaft and the first K0 clutch plates are non-rotatably connected, wherein the hub and the second K0 clutch plates are non-rotatably connected.

13. The hybrid module of claim 1, wherein the electric-motor stator is configured to drive the torque converter via the electric-motor rotor, the hub, and the torque converter cover when the electric-motor stator is engaged, wherein the K0 shaft is configured to drive the torque converter via the K0 clutch, the hub, and the torque converter cover when the K0 clutch is locked.

14. The hybrid module of claim 1, wherein the torque converter cover is configured to drive the torque converter hub through rotation of the torque converter cover, wherein the torque converter comprises an impeller and a turbine, wherein the torque converter is configured to drive the torque converter hub through rotation of the torque converter cover using the impeller and the turbine.

15. The hybrid module of claim 1, wherein the hybrid module comprises a K0 piston, wherein the K0 piston is configured to axially translate relative to the balance dam and the torque converter cover to lock and unlock the K0 clutch.

16. The hybrid module of claim 15, wherein the hybrid module comprises a hydraulic chamber, wherein the hydraulic chamber is axially disposed between and radially aligned with the K0 piston and the torque converter cover, wherein the hydraulic chamber is configured to be filled with oil, wherein the K0 piston is configured to axially translate towards the balance dam to lock the K0 clutch and axially translate away from the balance dam to unlock the K0 clutch.

17. The hybrid module of claim 16, wherein the torque converter cover defines an oil channel, wherein the hydraulic chamber is configured to receive the oil via the oil channel, wherein the oil channel is disposed radially inwards of and axially aligned with the hydraulic chamber, wherein the oil channel is only accessible from an axial opening defined by the torque converter hub.

18. The hybrid module of claim 16, wherein the hybrid module comprises a piston-compression spring, wherein the piston-compression spring is axially disposed between and radially aligned with the balance dam and the K0 piston, wherein the balance dam and the K0 piston are configured to compress the piston-compression spring when the K0 piston translates axially towards the balance dam and locks the K0 clutch, wherein the piston-compression spring is configured to return the K0 piston axially away from the balance dam and unlock the K0 clutch.

19. A hybrid powertrain comprising:
a hybrid module comprising:
an electric-motor stator;
an electric-motor rotor, the electric-motor stator and the electric-motor rotor configured as a radial flux motor;
a K0 shaft defining a shaft counterbore axially through the K0 shaft, the shaft counterbore comprising a pilot hole and a body hole,
a torque converter comprising a torque converter cover and a torque converter hub, the K0 shaft and the electric-motor stator configured to drive the torque converter;
a balance dam defining a dam socket;
a plate, the K0 shaft and the plate affixed together, the plate defining a plate socket;
a hub, the electric-motor rotor, the balance dam, the hub, and the torque converter cover are non-rotatably connected;
a K0 clutch disconnecting the K0 shaft and the hub when the K0 clutch is unlocked and non-rotatably connecting the K0 shaft and the hub when the K0 clutch is locked; and
a locking mechanism disconnecting the K0 shaft and the balance dam when the locking mechanism is unlocked and non-rotatably connecting the K0 shaft and the balance dam when the locking mechanism is locked, the locking mechanism comprising a pin, the pin comprising a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism; and
a transmission comprising a transmission input shaft, the transmission input shaft affixed to the torque converter hub.

20. A system comprising:
a hybrid module comprising:
an electric-motor stator;
an electric-motor rotor, the electric-motor stator and the electric-motor rotor configured as a radial flux motor;
a K0 shaft defining a shaft counterbore axially through the K0 shaft, the shaft counterbore comprising a pilot hole and a body hole,
a torque converter comprising a torque converter cover and a torque converter hub, the K0 shaft and the electric-motor stator configured to drive the torque converter;
a balance dam defining a dam socket;
a plate, the K0 shaft and the plate affixed together, the plate defining a plate socket;
a hub, the electric-motor rotor, the balance dam, the hub, and the torque converter cover are non-rotatably connected;
a K0 clutch disconnecting the K0 shaft and the hub when the K0 clutch is unlocked and non-rotatably connecting the K0 shaft and the hub when the K0 clutch is locked; and
a locking mechanism disconnecting the K0 shaft and the balance dam when the locking mechanism is unlocked and non-rotatably connecting the K0 shaft and the balance dam when the locking mechanism is locked, the locking mechanism comprising a pin, the pin comprising a circular portion and a drive portion, the pilot hole and the circular portion sealed together, the drive portion configured to engage with the plate socket and the dam socket, the pin configured to axially translate relative to the K0 shaft, the plate, and the balance dam, the pin spring-loaded to unlock the locking mechanism;
an assembly fixture housing, and
a pressure rod configured to be axially inserted through the assembly fixture housing and the K0 shaft up to the pin.
